(19) United States
(12) Patent Application Publication
(10) Pub. No.: US 2008/0130153 A1
(43) Pub. Date: Jun. 5, 2008

(54) HARD DISK DRIVE APPARATUS AND METHOD OF DECIDING DATA FORMAT OF HARD DISK DRIVE APPARATUS

(75) Inventors: Chul-Woo LEE, Seongnam-si (KR); Jae-Ik Song, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/943,044

(22) Filed: Nov. 20, 2007

(30) Foreign Application Priority Data
Nov. 30, 2006 (KR) 2006-119905

(51) Int. Cl. G11B 20/12

(52) U.S. Cl. 360/48

(57) ABSTRACT

A method of deciding a data format of a hard disk drive that includes assigning to a sector existing in a data zone of a disk a logical block address larger than a logical block address of a sector existing in an other data zone existing at an inner circumference with respect to the other data zone, according to a first data format in which data is recorded in an order from a data zone located at an inner circumference of the disk to a data zone located at an outer circumference of the disk with respect to a data zone located substantially in a middle of the innermost circumference and the outermost circumference of the disk.

### CROSS-REFERENCE TO RELATED APPLICATIONS

This application claims the priority under 35 U.S.C. §119(a) from Korean Patent Application No. 10-2006-119905, filed on Nov. 30, 2006, in the Korean Intellectual Property Office, the disclosure of which is incorporated herein in its entirety by reference.

### BACKGROUND OF THE INVENTION

1. Field of the Invention

The present general inventive concept relates to a hard disk drive apparatus, a method of deciding the data format of the hard disk drive apparatus, and a computer readable medium to record a computer program to perform the method, and more particularly, to a hard disk drive apparatus which is used for a portable electronic device and resists external shocks or vibrations so that reliability is improved, a method of deciding the data format of the hard disk drive apparatus, and a computer readable medium to record a computer program to perform the method.

2. Description of the Related Art

Hard disk drive apparatus (HDDs) formed of electronic parts and mechanical parts are memory devices to record and reproduce data by converting digital electric pulses to a magnetic field that is more permanent. The HDDs are widely used as auxiliary memory devices of computer systems because of fast access time to access a large amount of data.

User data is recorded on or reproduced from a disk in the HDD. The disk includes hundreds of tracks that are concentric to the center of the disk. Each of the tracks is divided into numerous sectors. A sector is the minimum unit to record or reproduce data and each sector generally provides a recording space of 512 bytes.

The circumferential lengths of tracks on the same disk are different from one another. That is, a track located at the outer circumference of a disk has a longer circumferential length. Due to this geometrical characteristic, to efficiently use a limited space of a disk, a track located at the outer circumference of a disk generally has more number of sectors than one located at the inner circumference of the disk. However, it is not that all tracks have the same number of sectors. A few neighboring tracks have the same number of sectors. These tracks are grouped into a zone. A disk structure in which a track located farther from the center of the disk has more sectors and a few neighboring tracks that also have the same number of sectors is referred to a zoned bit recording (ZBR) method.

When data is recorded on a disk according to the ZBR method, a data transfer rate in a zone increases as the zone is located at the outer circumference of the disk. This is because, while a zone located at the outer circumference has more number of sectors than that located at the inner circumference, the angular velocity of the disk is constant regardless of the position of a zone on the disk that is read. Thus, in most HDDs adopting the ZBR method, considering the disk performance, data is first recorded in the zones located at the outer circumference of a disk where the data transfer rate is fast and then in the zones located at the inner circumference of the disk in order.

Presently, the HDD is frequently used in consumer electronics (CE) or a car navigator that has portability. The HDD used for the portable electronic devices requires not only performance, but also stability with respect to operating shocks and vibrations that may impact the HDD.

However, the disk in the HDD typically has a characteristic that a portion of it located at the outer circumference from the center of the disk is more vulnerable to the operating shocks and vibrations. Thus, when the method of sequentially recording data from the outer circumference of a disk toward the inner circumference of the disk is applied uniformly, the HDD mounted in the portable electronic devices may be adversely impacted by the operating shocks and vibrations. Therefore, whether it is preferable to uniformly record data from the outer circumference toward the inner circumference of a disk needs to be reconsidered.

### SUMMARY OF THE INVENTION

The present general inventive concept provides a hard disk drive apparatus that is used for a portable electronic device and is resistant to external shocks or vibrations so that reliability is improved, a method of deciding the data format of the hard disk drive apparatus, and a computer readable medium to record a computer program to perform the method.

The present general inventive concept provides a hard disk drive apparatus which allows a user to select a data format suitable for an environment in which it is used such as to improve performance in an environment where external shocks or vibrations are small and to be resistant to external shocks and vibrations so that reliability is improved in an environment where external shocks or vibrations are great, a method of deciding the data format of the hard disk drive apparatus, and a computer readable medium to record a computer program to perform the method.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may also be achieved by providing a method of deciding a data format of a hard disk drive apparatus which includes assigning to a sector existing in a data zone of a disk a logical block address larger than a logical block address of a sector existing in an other data zone disposed at an inner circumference with respect to the other data zone, according to a first data format in which data is recorded in an order from a data zone located at an inner circumference of the disk to a data zone located at an outer circumference of the disk with respect to a data zone located substantially in a middle of the innermost circumference and the outermost circumference of the disk.

In the logical block address assigning operation, a smaller logical block address may be assigned to a sector existing on a same cylinder of the disk as a head number of a sector decreases.

In the logical block address assigning operation, a smaller logical block address may be assigned to a sector existing on a same data zone of the disk as a cylinder number of a sector decreases.

In the logical block address assigning operation, a smaller logical block address may be assigned to a sector existing on a same track of the disk as a sector number of a sector decreases.

The foregoing and/or other aspects and utilities of the present general inventive concept may also be achieved by a method of deciding a data format of a hard disk drive apparatus which includes selecting any one of a first data format in which data is recorded in an order from a data zone located at an inner circumference of a disk to a data zone located at an outer circumference of the disk with respect to a data zone located substantially in a middle of the innermost circumference and the outermost circumference of the disk and a second data format in which data is recorded in an order from a data zone located at the outer circumference of the disk to a data zone located at the inner circumference of the disk with respect to a data zone located substantially in the middle of the innermost circumference and the outermost circumference of the disk, and assigning to a first sector existing in a data zone of the disk a logical block address larger than a logical block address of a sector existing in a data zone disposed at the inner circumference with respect to the data zone corresponding to the first sector, when the first data format is selected, and assigning to a second sector existing in a data zone of the disk a logical block address larger than a logical block address of a sector existing in a data zone disposed at the outer circumference with respect to the data zone corresponding to the second sector, when the second data format is selected.

The foregoing and/or other aspects and utilities of the present general inventive concept may also be achieved by providing a computer readable medium to record a computer program to perform a method of deciding a data format of a hard disk drive apparatus, the method including assigning to a sector existing in a data zone of a disk a logical block address larger than a logical block address of a sector existing in an other data zone disposed at an inner circumference with respect to the other data zone, according to a first data format in which data is recorded in an order from a data zone located at an inner circumference of the disk to a data zone located at an outer circumference of the disk with respect to a data zone located substantially in a middle of the innermost circumference and the outermost circumference of the disk.

The foregoing and/or other aspects and utilities of the present general inventive concept may also be achieved by a hard disk drive apparatus including a disk where data is recorded or reproduced, and a controller to assign to a sector existing in a data zone of a disk a logical block address larger than a logical block address of a sector existing in an other data zone disposed at an inner circumference with respect to the other data zone, according to a first data format in which data is recorded in an order from a data zone located at an inner circumference of the disk to a data zone located at an outer circumference of the disk with respect to a data zone located substantially in the middle of the innermost circumference and the outermost circumference of the disk.

The controller may assign a smaller logical block address to a sector existing on a same cylinder of the disk as a head number of a sector decreases.

The controller may assign a smaller logical block address to a sector existing on a same data zone of the disk as a cylinder number of a sector decreases.

The controller may assign a smaller logical block address to a sector existing on a same track of the disk as a sector number of a sector decreases.

The foregoing and/or other aspects and utilities of the present general inventive concept may also be achieved by a hard disk drive apparatus including a disk where data is recorded or reproduced, and a controller to select any one of a first data format in which data is recorded in an order from a data zone located at an inner circumference of the disk to a data zone located at an outer circumference of the disk with respect to a data zone located substantially in a middle of the innermost circumference and the outermost circumference of the disk and a second data format in which data is recorded in an order from a data zone located at the outer circumference of the disk to a data zone located at the inner circumference of the disk with respect to a data zone located substantially in the middle of the innermost circumference and the outermost circumference of the disk, and assigning to a first sector existing in a data zone of the disk a logical block address larger than a logical block address of a sector existing in a data zone disposed at the inner circumference with respect to the data zone corresponding to the first sector, when the first data format is selected, and assigning to a second sector existing in a data zone of the disk a logical block address larger than a logical block address of a sector existing in a data zone disposed at the outer circumference with respect to the data zone corresponding to the second sector, when the second data format is selected.

The foregoing and/or other aspects and utilities of the present general inventive concept may also be achieved by a method of selecting a data format of a hard disk drive apparatus (HDD), the method including selecting one of a first data format and a second data format, wherein the first data format and the second data format correspond to an order in which data is recorded between a data zone disposed at an inner circumference of a disk and a data zone disposed at an outer circumference of the disk.

The foregoing and/or other aspects and utilities of the present general inventive concept may also be achieved by providing a method of selecting a data format of a hard disk drive apparatus (HDD), the method including selecting a data format corresponding to an order in which the data is recorded from a data zone disposed at an inner circumference of a disk to a data zone disposed at an outer circumference of the disk, wherein the selecting of the data format is based on the HDD being used in a portable electronic unit.

The foregoing and/or other aspects and utilities of the present general inventive concept may also be achieved by providing a hard disk drive apparatus (HDD), including a disk having data recorded thereto and read therefrom, and a controller to select a data format corresponding to an order in which the data is recorded from a data zone disposed at an inner circumference of a disk to a data zone disposed at an outer circumference of the disk based on the HDD being used in an environment conducive to at least one of vibrations and shock.

The foregoing and/or other aspects and utilities of the present general inventive concept may also be achieved by providing a hard disk drive apparatus, including a disk having data recorded thereto and read therefrom, and a controller to select one of a first data format and a second data format, wherein the first data format and the second data format correspond to an order in which data is recorded between a data zone disposed at an inner circumference of a disk and a data zone disposed at an outer circumference of the disk.

The foregoing and/or other aspects and utilities of the present general inventive concept may also be achieved by providing an electronic apparatus including a user interface, and a hard disk drive apparatus (HDD) coupled to the user interface, including a disk having data recorded thereto and read therefrom, and a controller to select a data format corresponding to an order in which the data is recorded from a data zone disposed at an inner circumference of a disk to a data zone disposed at an outer circumference of the disk based on the HDD being used in an environment conducive to at least one of vibrations and shock.

The foregoing and/or other aspects and utilities of the present general inventive concept may also be achieved by providing a hard disk drive apparatus including a head to read data from a disk, a controller to analyze the data to identify a logical block address of the disk corresponding to the data and a processor to process the data based on the logical block address identified.

The foregoing and/or other aspects and utilities of the present general inventive concept may also be achieved by providing a method of operating a hard disk drive apparatus, the method including reading data from a disk, analyzing the data to identify a logical block address of the disk corresponding to the data and processing the data based on the logical block address identified.

The foregoing and/or other aspects and utilities of the present general inventive concept may also be achieved by providing hard disk drive apparatus including a disk having data to be recorded and read, a head to read from the disk and record to the disk the data, a controller to select a data format corresponding to an order in which the data is recorded by the head from a data zone disposed at an inner circumference of a disk to a data zone disposed at an outer circumference of the disk, and to analyze the data read by the head to identify a logical block address of the disk corresponding to the data and a processor to process the data based on the logical block address identified.

The foregoing and/or other aspects and utilities of the present general inventive concept may also be achieved by providing A method of operating a hard disk drive apparatus, the method including reading from and/or recording to a disk data, selecting a data format corresponding to an order in which data is recorded, analyzing the data read to identify a logical block address of the disk corresponding to the data read, and processing the data based on the logical block address identified.

The foregoing and/or other aspects and utilities of the present general inventive concept may also be achieved by providing An apparatus usable with a hard disk drive having the disk, the apparatus including a controller to select a data format corresponding to an order in which the data is recorded from a data zone disposed at an inner circumference of a disk to a data zone disposed at an outer circumference of the disk based on the HDD being used in an environment conducive to at least one of vibrations and shock.

The foregoing and/or other aspects and utilities of the present general inventive concept may also be achieved by providing An apparatus usable with a hard disk drive having a disk, the apparatus including a controller to analyze the data to identify a logical block address of the data on the disk and a processor to process the data based on the logical block address identified.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a partially exploded perspective view illustrating a hard disk drive according to an embodiment of the present general inventive concept;

FIG. 2 is a perspective view illustrating a disk portion of the hard disk drive of FIG. 1;

FIG. 3 is a block diagram illustrating a drive circuit of the hard disk drive of FIG. 1;

FIG. 4 is a partial sectional view illustrating one side of the disk of FIG. 2; and

FIGS. 5A and 5B are flowcharts illustrating a method of deciding a data format of the hard disk drives of FIGS. 1 and 2 according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

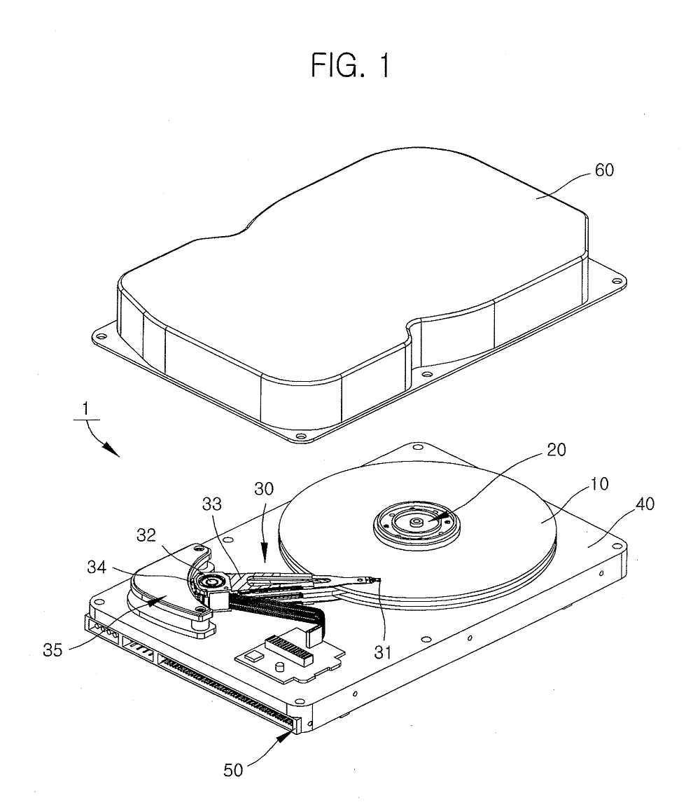

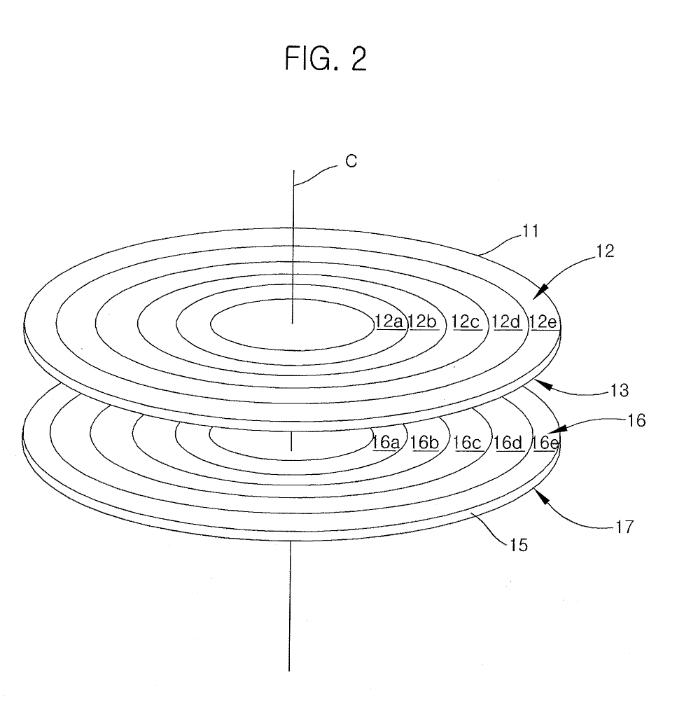

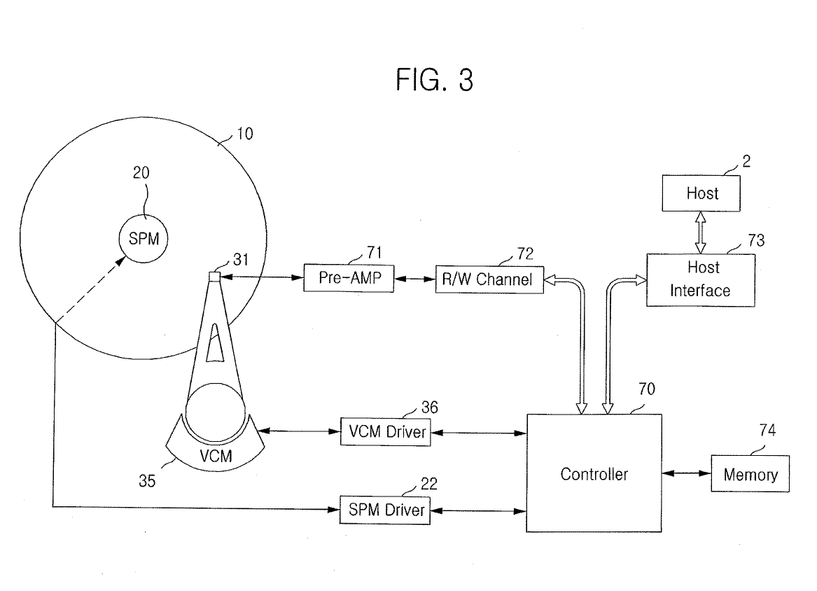

FIG. 1 is a partially exploded perspective view illustrating a hard disk drive according to an embodiment of the present general inventive concept. FIG. 2 is a perspective view illustrating a disk portion of the hard disk drive of FIG. 1. FIG. 3 is a block diagram of a drive circuit illustrating the hard disk drive of FIG. 1. Referring to FIG. 1, a hard disk drive (HDD) 1 according to an embodiment of the present general inventive concept includes a disk 10 recording and storing data, a spindle motor 20 supporting and rotating the disk 10, a head stack assembly (HSA) 30 reading out data on the disk 10, a base 40 to which the above elements are assembled, a printed circuit board assembly (PCBA) 50 coupled to the lower portion of the base 40 and controlling various parts by installing most circuit parts on a printed circuit board (PCB), and a cover 60 covering the upper portion of the base 40.

The disk 10 is a place where data is recorded and stored and generally provided in multiple numbers. In the present embodiment, as illustrated in FIG. 2, two disks including an upper disk 11 and a lower disk 15 are provided. Both sides of the disk 10 are used as a data storage space. That is, upper and lower surfaces 12 and 13 of the upper disk 11 and upper and lower surfaces 16 and 17 of the lower disk 15 are all used as data storage spaces. These four recording surfaces 12, 13, 16, and 17 are sectioned in the same method and the following description focuses on the upper surface 12 of the upper disk 11.

The upper surface 12 of the upper disk 11, as illustrated in FIG. 2, has five zones 12a through 12e which are concentric with a rotation shaft C of the disk 10. For reference, there may be a zone such as a maintenance cylinder (not illustrated) which is not related to data recording on the disk 10 of the HDD 1. In the present embodiment, however, all of the five zones 12a through 12e are regarded as a zone related to data recording (hereinafter, referred to as the data zone) for the convenience of explanation. These five zones 12a through 12e form a single data area. Each of the five data zones 12a through 12e is sectioned into a plurality of tracks that are concentric with the rotation shaft C and each of the tracks is divided into a plurality of sectors. The disk 10 according to the present embodiment is sectioned in the zoned bit recording (ZBR) method. Accordingly, the five data zones 12a through 12e are sectioned such that a data zone located farther from the rotation shaft C has more sectors belonging to a track in the data zones 12a through 12e. Thus, the data transfer rate of the data zone 12e located at the outermost circumference is the fastest while that of the data zone 12a located at the innermost circumference is the slowest, as the angular velocity of the disk is constant regardless of the position of the zone on the disk that is read.

All sectors on the disk 10 have head numbers, cylinder numbers, and sector numbers. The sectors existing on the same recording surface of the disk 10 have the same head number. The head numbers sequentially increasing by one downwardly from the upper recording surface are assigned to the sectors existing on the same recording surface. Thus, in the present embodiment, the head numbers of 0, 1, 2, and 3 are sequentially assigned to the sectors belonging to the four recording surfaces 12, 13, 16, and 17.

A set of tracks located at the same distance from the rotation shaft C is referred to as a cylinder. The sectors on the same cylinder have the same cylinder number regardless of the position on the recording surface of the disk 10. The cylinder numbers increase by one from the outer circumference toward the inner circumference of the disk 10. Accordingly, the sectors existing on the track at the outermost circumference of the disk 10 have the lowest cylinder number of “0” while the sectors existing on the track at the innermost circumference of the disk 10 have the highest cylinder number. In the present embodiment, when each of the five data zones 12a through 12e is sectioned into 10 tracks, the disk 10 has a total of 50 cylinders so that the cylinder numbers are “0” to “49”.

Also, when one of the sectors existing on a track has a sector number “0”, the other sectors have sector numbers that sequentially increase by one clockwise or counterclockwise. In the present embodiment, when a track is sectioned into 100 sectors, the sectors existing on the track have the sector number of “0” to “99”.

The spindle motor 20 rotates the disk 10 by receiving a control signal of a controller 70. Although the rotational angular velocity of the spindle motor 20 includes 3,600 rpm, 5,400 rpm, 7,200 rpm, and 10,000 rpm, the scope of the present general inventive concept is not limited thereto.

The head stack assembly 30 is a carriage to record data on the disk 10 or reproduce the recorded data and includes a magnetic head 31 recording data on the disk 10 or reading the recorded data, an actuator arm 33 rotating around a pivot shaft 32 above the disk 10 so that the magnetic head 31 can access the data on the disk 10, a pivot shaft holder 34 supporting the pivot shaft 32 capable of rotating and to which the actuator arm 33 is coupled and supported, and a voice coil motor (VCM) 35 rotating the actuator arm 33 and provided at the opposite side of the actuator arm 33 with respect to the pivot shaft holder 34.

The magnetic head 31 can reproduce data from the disk 10 by detecting a magnetic field formed on the surface of the disk 10 or record data on the disk 10 by magnetizing the surface of the disk 10. The magnetic head 31 is arranged at a predetermined height from a recording surface of the disk 10 stacked above the base 40. The magnetic head 31 can be arranged at both or one of the sides of the disk 10. In the present embodiment, since data is recorded on both sides of each of the disks 11 and 12, the magnetic head 31 is provided corresponding to each of the four recording surfaces 12, 13, 16, and 17.

The actuator arm 33 has one end that is connected to the magnetic head 31 and the other end that is coupled to the pivot shaft 32 capable of rotating the magnetic head 31 relative to the pivot shaft 32. The actuator arm 33 extends long so that the magnetic head 31 can freely move above the surface of the disk 10. The pivot holder 34 supports the pivot shaft 32 capable of rotating and supports the actuator arm 33 coupled to the pivot shaft holder 34.

The VCM 35 rotates the actuator arm 34 around the pivot shaft 32. The VCM 35 includes a voice coil (not illustrated) and a magnet (not illustrated). The VCM 35 rotates the actuator arm 33 in a direction following the Fleming's left hand rule, by an electromotive force generated by the interaction between a magnetic force generated by the magnet and current flowing in the voice coil. In the present embodiment, the VCM 35 rotates the actuator arm 33. However, the VCM 35 can be replaced by a stepper motor that rotates the actuator arm 33 by a predetermined angle according to an input signal. The VCM 35 is advantageous in that it is resistant to heat, no periodic format is required, and reliability of the VCM 35 is high.

The HDD 1 according to the present embodiment includes a drive circuit to control the above-described elements of the HDD 1. So the HDD 1, as illustrated in FIG. 3, includes a preamplifier (Pre-AMP) 71, a read/write (R/W) channel 72, a host interface 73, a VCM driver 36, a spindle motor (SPM) driver 22, and the controller 70.

The Pre-AMP 71 amplifies a data signal reproduced by the magnetic head 31 from the disk 10 or a recording current converted by the R/W channel 72. In a data read mode to reproduce the data recorded on the disk 10, the R/W channel 72 converts a signal reproduced by the magnetic head 31 from the disk 10 and amplified by the Pre-AMP 71 to a digital signal and inputs the digital signal to the controller 70. In a data write mode to write data to the disk 10, the R/W channel 72 receives user input data from the host interface 73, through the controller 70, converts the input data to a binary data stream which is easy to write, and outputs the converted data to the Pre-AMP 71.

A host device 2 such as a CPU or I/O controller of a computer is used as collective elements that controls and operates a computer including the HDD 1. The host interface 73, in the data read mode, transfers the data converted to a digital signal to the host device 2 and, in the data write mode, receives the data input by a user from the host device 2 and outputs the received data to the controller 70.

The VCM driver 36 receives a control signal of the controller 70 and controls the amount of current applied to the VCM 35. The SPM driver 22 receives the control signal of the controller 70 and controls the amount of current applied to the spindle motor 20.

The controller 70, in the data write mode, receives the user input data from the host device 2 through the host interface 73 and outputs the received data to the R/W channel 72. In the data read mode, when the R/W channel 72 converts the data signal reproduced by the magnetic head 31 and amplified by the Pre-AMP 71 to a digital signal, the controller 70 receives the converted signal and outputs the received signal to the host interface 73. The controller 70 controls the VCM 35 to move the magnetic head 31 to a desired position on the disk 10. The controller 70 controls the spindle motor 20 to control the rotation speed of the disk 10.

The controller 70 may be a digital signal processor (DSP), a microprocessor, or a micro controller. A method of deciding the data format of the HDD 1 will be described below and can be embodied by the controller 70, for example, in a form of software or firmware.

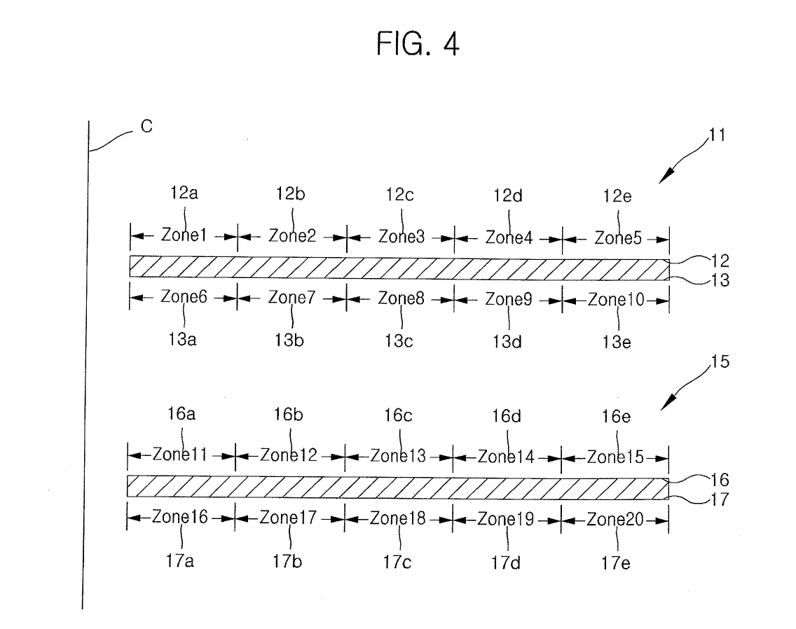

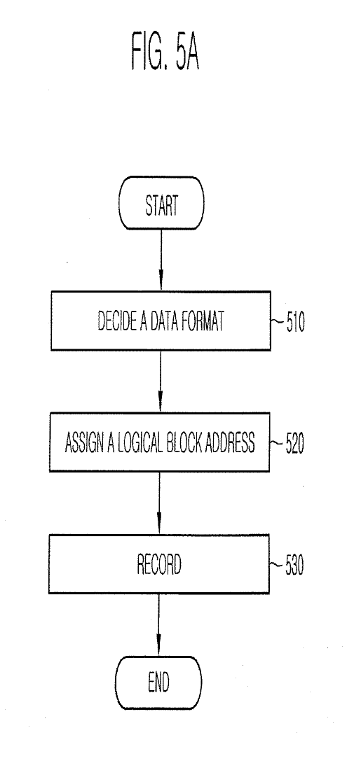

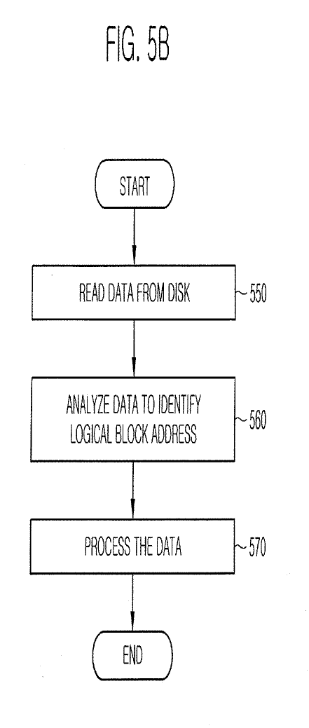

The method of deciding the data format of the HDD 1 according to an embodiment of the present general inventive concept will be described in detail with reference to FIGS. 4, 5A and 5B. FIG. 4 is a partial sectional view illustrating one side of the disk 10 of FIG. 2, and FIGS. 5A and 5B are flowcharts illustrating the method.

The method of deciding the data format of the HDD 1 is performed by selecting the data format of a hard disk drive (Operation 510) and assigning a logical block address (LBA) to each of the sectors on the disk 10 according to the selected data format (Operation 520). In an embodiment of the present invention, recording data (Operation 530) based on an order of the assignment of logical block addresses.

In Operation 510, selecting the data format of the hard disk drive 1 includes the data format signifying a plan to fill the data area formed of a plurality of sectors on the disk 10 in a certain order. The HDD 1, according to this embodiment of the present general inventive concept, allows a user to select one of two data formats, that is, a first data format and a second data format, for example, in Operation 510. The first and second data formats are divided according to whether recording starts from the data zone at the outer circumference on the disk 10 or from the data zone at the inner circumference on the disk 10 in Operation 530. In the present embodiment, the data format of recording data from the data zone at the inner circumference on the disk 10 is referred to as the first data format while the data format of recording data from the data zone at the outer circumference on the disk 10 is referred to as the second data format.

As illustrated in FIG. 4, each of the four recording surfaces 12, 13, 16 and 17 of the disk 10 has five data zones 12a to 17e. Each data zone is sectioned into a plurality of tracks and each track is sectioned by a plurality of sectors.

According to the first data format, in Operation 530 data is recorded from the data zone located at the innermost circumference of the disk 10. The data zone located at the innermost circumference of the disk 10 exists on each of the recording surfaces of the disk 10. That is, as illustrated in FIG. 4, zone 1 12a, zone 6 13a, zone 11 16a, and zone 16 17a correspond to the data zones at the innermost circumference of the disk 10. In Operation 530, when the data is recorded in these four data zones so that the data zones are completely filled, data is then recorded in zone 2 12b, zone 7 13b, zone 12 16b, and zone 17 17b neighboring these data zones. Thus, the data zones where the data is finally recorded are zone 5 12e, zone 10 13e, zone 15 16e, and zone 20 17e located at the outermost circumference of the disk 10.

However, since the typical operation of recording or reproducing data in the HDD 1 is performed in units of sectors, the data recording order in the data format needs to be finally decided in units of “sectors” not in units of “zones”. Thus, the first data format needs to be specified. That is, the recording order of the data zones at a same distance from the rotation shaft C of the disk 10 needs to be determined, the recording order of the tracks in the same data zone needs to be determined, and the recording order of the sectors on the same track finally needs to be determined.

The recording order of the data zones located at the same distance from the rotation shaft C of the disk 10 may have a variety of combinations. In the present embodiment, in Operation 530, data is recorded in an order from a data zone having a sector with the lowest head number. As described above, the head number “0” is assigned to the recording surface 12 of the disk 10 located at the uppermost position and the head number increases by one downwardly. Accordingly, in Operation 520, the head numbers are assigned to the data zones located at the innermost circumference of the disk 10, for example, the head number “0”, the head number “1”, the head number “2”, and the head number “3” are respectively assigned to the zone 1 12a, the zone 6 13a, the zone 11 16a, and the zone 16 17a. Thus, the recording order of these four data zones is the order of the zone 1 12a, the zone 6 13a, the zone 11 16a, and the zone 16 17a as the head number increases.

Although the recording order of tracks in the same data zone may have a variety of combinations, in the present embodiment, in Operation 510, data is recorded first on a track having a lower cylinder number. As described above, in Operation 520, the cylinder number “0” is assigned to a track at the outermost circumference of the disk 10 and the cylinder number of tracks increases by one from the outer circumference toward the inner circumference. Thus, the recording order of tracks in the same data zone is from the outer circumference toward the inner circumference. Likewise, although the recording order of sectors in the same track may have a variety of combinations, in the present embodiment, data is recorded in an order from a sector having a lower sector number to a sector having a higher sector number.

According to the second data format, in Operation 510, data is recorded first in a data zone located at the outermost circumference of the disk 10. The zone 5 12e, the zone 10 13e, the zone 15 16e, and the zone 20 17e are the data zones located at the outermost circumference. When these four zones are completely recorded with data, data will be then recorded in zone 4 12d, zone 9 13d, zone 14 16d, and zone 19 17d adjacent to the above four data zones. Finally, in Operation 530, data is recorded in the data zones located at the innermost circumference of the disk 10, that is, the zone 1 12a, the zone 6 13a, the zone 11 16a, and the zone 16 17a.

In the second data format, the recording order of data is finally decided in unit of sectors, not zones. Thus, like the first data format, the recording order of the data zones located at the same distance from the rotation center C of the disk 10 is decided, the recording order of tracks in the same data zone is decided, and the recording order of sectors in the same track is finally decided. These three recording orders are the same as those of the above-described first data format.

In the comparison of the first data format and the second data format, when the first data format is selected, user data is recorded from the data zones located at the inner circumference of the disk 10. Accordingly, the data transfer rate of HDD1 decreases, but HDD1 is resistant to external shock and vibration. When the second data format is selected, the user data is recorded from the data zones located at the outer circumference of the disk 10. Accordingly, the data transfer rate increases, but HDD1 is susceptible to external shock and vibration, compared to selecting the first data format. Thus, a user of the HDD 1 can select the data format according to whether a system employing the HDD 1 requires a superior data transfer rate or a characteristic of being resistant to external shock or vibration.

In an embodiment of the present general inventive concept, the selection of the data format is preferably limited to one time. This is because if the data format is changed to the other data format after the one data format is selected and a certain amount of data was recorded using the one data format, an error is highly likely to occur in accessing data.

Next, in Operation 520, the logical block address (LBA) is assigned to each of the sectors on the disk 10 according to the selected data format. That is, the LBA is used as information on the selected data format. A cylinder head sector CHS is a concept corresponding to the LBA. Both of the LBA and the CHS are related to a method to assign an address to the sector of the disk 10 of the HDD 1. According to the CHS method, an address is assigned to a corresponding sector using three-dimensional information about the cylinder, head, and sector of a particular sector, that is, a sector is assigned in a form of the 98^{th} sector belonging to the 25^{th} cylinder and matching the second magnetic head. However, in the CHS method, since an address needs to be assigned using the three-dimensional information with respect to a particular sector, there is a limit in the parameters of the CHS that the host device 2 assigns. The LBA is introduced to solve the above problem. According to the LBA, not the three dimensional information of the disk 10 of the HDD 1, but all sectors of the disk 10 are assigned serial numbers from “0” to “N” in order so that the address of the sector is assigned in Operation 520. Thus, theoretically the sector address assignment in units of several to tens of giga bytes (GB) is possible. In general, the LBA information is transceived between the host device 2 and the HDD 1. The LBA is translated into the CHS by firmware included in the controller 70 of the HDD 1. Thus, in Operation 530, the magnetic head 31 accesses the sector according to the CHS information to record or reproduce data.

When giving a command to record data to the HDD 1, in Operation 520 the host device 2 assigns a sector where the data is recorded. The sector where the data is to be recorded, in Operation 530, is assigned in an order from a sector having a lower LBA value in Operation 520. Thus, the sector on the disk 10 have the LBA value according to the data recording order that is determined according to the selected data format. Selecting the first data format in the above-described data format selection operation is described below.

When the first data format is selected in Operation 510, the data zones located at the innermost circumference of the disk 10, that is, the zone 1 12a, the zone 6 13a, the zone 11 16a, and the zone 16 17a, are first recorded. Accordingly, in Operation 530, data zones are recorded in an order from a data zone having a smaller head number to a data zone having a larger head number. To record data in this recording order, in Operation 520, the order of assigning the LBA to sectors existing in the data zones follows the order of the zone 1 12a, the zone 6 13a, the zone 11 16a, and the zone 16 17a. Accordingly, the sectors belonging to the zone 1 12a of the four data zones is assigned to the smallest LBA value while the sectors belonging to the zone 16 17a is assigned to the largest LBA value.

Also, when the first data format is selected, for example, in Operation 510, the LBA is assigned to each sector according to the data recording order of the sectors belonging to each of the data zones, for example, in Operation 520. That is, as described above, when the first data format is selected, in Operation 530 data is recorded in an order from the sectors existing on a track having a smaller cylinder number of the sectors in the same data zone to the sectors existing on a track having a larger cylinder number. In the same track, in Operation 530, data is recorded in an order from a sector having a lower sector number to a sector having a larger sector number. Thus, in Operation 520, when the LBA is assigned to the sectors belonging to an arbitrary data zone existing on the disk 10 to have data recorded on the disk 10 according to the first data format, a smaller LBA value is assigned to the sectors belonging to the track having a smaller cylinder number. As the sector number decreases, for example, in Operation 520, a smaller LBA value is assigned to the sectors in the same track.

For reference, when the second data format is selected, for example, in Operation 510, it is different in that a smaller LBA is assigned to the data zone located at the outer circumference of the disk 10 compared to the data zone located at the relatively inner circumference of the disk 10, for example, in Operation 520. However, the order of assigning the LBA to the sectors belonging to the same data zone is the same as that in the first data format.

Referring to FIGS. 1, 3 and 5B, in an embodiment of the present general inventive concept, in Operation 550, data may be read from a disk 10. In Operation 560, the data may be analyzed to identify a logical block address of the disk corresponding to the data. In Operation 570, the data may be processed based on the logical block address identified. In an embodiment of the present general inventive concept, a hard disk drive apparatus 1 may a disk 10 having data to be recorded and read, and a head 31 to read from the disk 10 and record to the disk 10 the data. The HDD 1 may also include a controller 70 to select a data format corresponding to an order in which the data is recorded by the head 31 from a data zone disposed at an inner circumference of a disk to a data zone disposed at an outer circumference of the disk 1 and to analyze the data read by the head 31 to identify a logical block address of the disk 10 corresponding to the data. The HDD 1 may also include a processor to process the data based on the logical block address identified. In another embodiment of the present general inventive concept, for example, the controller 70 and/or processor may be included in a remote controller.

As described above, when the method of deciding the data format of the HDD 1 by selecting a data format (Operation 510) and assigning the LBA to each of the sectors on the disk 10 (Operation 520) according to the selected data format is used, a user can selectively decide the data format suitable for the environment where the HDD 1 is to be used. That is, when the HDD 1 is used by being mounted on a portable electronic device, the user selects the first data format in which data is stored from the innermost circumference of the data area of the disk 10 toward the outer circumference. Thus, although the performance of the HDD 1 deteriorates as the data transfer rate decreases, the HDD 1 can be resistant to external shock or vibration. Alternatively, when the HDD 1 is used in an environment where the external shock or vibration is negligible, the second data format in which data is stored from the outermost circumference of the data area of the disk 10 toward the inner circumference is selected. Thus, as the data transfer rate increases, the performance of the HDD 1 is improved.

Although a few embodiments of the present general inventive concept have been illustrated and described, the present general inventive concept is not limited to the described embodiments. Instead, it would be appreciated by those skilled in the art that changes may be made to these embodiments without departing from the principles and spirit of the general inventive concept, the scope of which is defined by the claims and their equivalents.

According to the above-described embodiments of the present general inventive concept, when the HDD according to the present general inventive concept is used for a portable electronic device, the HDD is resistant to external shock or vibration so that reliability can be improved. Also, according to the present general inventive concept, a user selects a data format suitable for the environment that the HDD is to be used so that the performance of the HDD is improved, for example, in the environment where the external shock or vibration is small. Alternatively, in an environment where the external shock or vibration is great, a data format is selected so that the HDD is resistant to the external shock or vibration so that the reliability of the HDD is improved.

The present general inventive concept can also be embodied as computer-readable codes on a computer-readable medium. The computer-readable medium is any data storage device that can store data that can be thereafter read by a computer system. Examples of the computer-readable medium include read-only memory (ROM), random-access memory (RAM), CD-ROMs, magnetic tapes, floppy disks, optical data storage devices, and carrier waves (such as data transmission through the Internet). The computer-readable medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of deciding a data format of a hard disk drive apparatus, the method comprising:
assigning to a sector existing in a data zone of a disk a logical block address larger than a logical block address of a sector existing in an other data zone disposed at an inner circumference with respect to the other data zone, according to a first data format in which data is recorded in an order from a data zone located at an inner circumference of the disk to a data zone located at an outer circumference of the disk with respect to a data zone located substantially in a middle of the innermost circumference and the outermost circumference of the disk.

2. The method of claim 1, wherein in the logical block address assigning operation a smaller logical block address is assigned to a sector existing on a same cylinder of the disk as a head number of a sector decreases.

3. The method of claim 1, wherein in the logical block address assigning operation a smaller logical block address is assigned to a sector existing on a same data zone of the disk as a cylinder number of a sector decreases.

4. The method of claim 1, wherein in the logical block address assigning operation a smaller logical block address is assigned to a sector existing on a same track of the disk as a sector number of a sector decreases.

5. A method of deciding a data format of a hard disk drive apparatus, the method comprising:
selecting any one of a first data format in which data is recorded in an order from a data zone located at an inner circumference of the a to a data zone located at an outer circumference of the disk with respect to a data zone located substantially in a middle of the innermost circumference and the outermost circumference of the disk and a second data format in which data is recorded in an order from a data zone located at the outer circumference of the disk to a data zone located at the inner circumference of the disk with respect to a data zone located substantially in the middle of the innermost circumference and the outermost circumference of the disk; and
assigning to a first sector existing in a data zone of the disk a logical block address larger than a logical block address of a sector existing in a data zone disposed at the inner circumference with respect to the data zone corresponding to the first sector, when the first data format is selected, and assigning to a second sector existing in a data zone of the disk a logical block address larger than a logical block address of a sector existing in a data zone disposed at the outer circumference with respect to the data zone corresponding to the second sector, when the second data format is selected.

6. A computer readable medium to record a computer program to perform a method of deciding a data format of a hard disk drive apparatus, the method comprising:
assigning to a sector existing in a data zone of a disk a logical block address larger than a logical block address of a sector existing in an other data zone disposed at an inner circumference with respect to the other data zone, according to a first data format in which data is recorded in an order from a data zone located at an inner circumference of the disk to a data zone located at an outer circumference of the disk with respect to a data zone located substantially in a middle of the innermost circumference and the outermost circumference of the disk.

7. A hard disk drive apparatus, comprising:
a disk where data is recorded or reproduced; and
a controller to assign to a sector existing in a data zone of a disk a logical block address larger than a logical block address of a sector existing in an other data zone disposed at an inner circumference with respect to the other data zone, according to a first data format in which data is recorded in an order from a data zone located at an inner circumference of the disk to a data zone located at an outer circumference of the disk with respect to a data zone located substantially in a middle of the innermost circumference and the outermost circumference of the disk.

8. The apparatus of claim 7, wherein the controller assigns a smaller logical block address to a sector existing on a same cylinder of the disk as a head number of a sector decreases.

9. The apparatus of claim 7, wherein the controller assigns a smaller logical block address to a sector existing on a same data zone of the disk as a cylinder number of a sector decreases.

10. The apparatus of claim 7, wherein the controller assigns a smaller logical block address to a sector existing on a same track of the disk as a sector number of a sector decreases.

11. A hard disk drive apparatus, comprising:
a disk where data is recorded or reproduced; and
a controller to select any one of a first data format in which data is recorded in an order from a data zone located at an inner circumference of the disk to a data zone located at an outer circumference of the disk with respect to a data zone located substantially in a middle of the innermost circumference and the outermost circumference of the disk and a second data format in which data is recorded in an order from a data zone located at the outer circumference of the disk to a data zone located at the inner circumference of the disk with respect to a data zone located substantially in the middle of the innermost circumference and the outermost circumference of the disk, and assigning to a first sector existing in a data zone of the disk a logical block address smaller than a logical block address of a sector existing in a data zone disposed at the inner circumference with respect to the data zone corresponding to the first sector, when the first data format is selected, and assigning to a second sector existing in a data zone of the disk a logical block address larger than a logical block address of a sector existing in a data zone disposed at the outer circumference with respect to the data zone corresponding to the second sector, when the second data format is selected.

12. A method of selecting a data format of a hard disk drive apparatus (HDD), the method comprising:
selecting one of a first data format and a second data format,
wherein the first data format and the second data format correspond to an order in which data is recorded between a data zone disposed at an inner circumference of a disk and a data zone disposed at an outer circumference of the disk.

13. The method of claim 12, wherein the selecting operation is based on an environment the HDD is to be used.

14. The method of claim 12, wherein:
the first data format corresponds to the order in which the data is recorded from the data zone disposed at the inner circumference of the disk to the data zone disposed at the outer circumference of the disk, and
the second data format corresponds to the order in which the data is recorded from the data zone disposed at the outer circumference of the disk to the data zone disposed at the inner circumference of the disk.

15. The method of claim 12, further comprising:
assigning logical block addresses to sectors of a data zone, respectively,
wherein the logical block addresses increase or decrease based on the data format selected and relative positions of the sectors between a data zone disposed at an inner circumference of a disk and a data zone disposed at an outer circumference of the disk.

16. The method according to claim 15, wherein the logical block addresses increase from a data zone disposed at an inner circumference of a disk and a data zone disposed at an outer circumference of the disk when the first data format is selected.

17. The method according to claim 15, wherein the logical block addresses decrease from a data zone disposed at an inner circumference of a disk to a data zone disposed at an outer circumference of the disk, when the second data format is selected.

18. A method of selecting a data format of a hard disk drive apparatus (HDD), the method comprising:
selecting a data format corresponding to an order in which the data is recorded from a data zone disposed at an inner circumference of a disk to a data zone disposed at an outer circumference of the disk,
wherein the selecting of the data format is based on the HDD being used in a portable electronic unit.

19. A hard disk drive apparatus (HDD), comprising:
a disk having data recorded thereto and read therefrom; and
a controller to select a data format corresponding to an order in which the data is recorded from a data zone disposed at an inner circumference of a disk to a data zone disposed at an outer circumference of the disk based on the HDD being used in an environment conducive to at least one of vibrations and shock.

20. A hard disk drive apparatus, comprising:
a disk having data recorded thereto and read therefrom; and
a controller to select one of a first data format and a second data format,
wherein the first data format and the second data format correspond to an order in which data is recorded between a data zone disposed at an inner circumference of a disk and a data zone disposed at an outer circumference of the disk.

21. An electronic apparatus, comprising:
a user interface; and
a hard disk drive apparatus (HDD) coupled to the user interface, including:
a disk having data recorded thereto and read therefrom; and
a controller to select a data format corresponding to an order in which the data is recorded from a data zone disposed at an inner circumference of a disk to a data zone disposed at an outer circumference of the disk based on the HDD being used in an environment conducive to at least one of vibrations and shock.

22. A hard disk drive apparatus, comprising:
a head to read data from a disk;
a controller to analyze the data to identify a logical block address of the disk corresponding to the data; and
a processor to process the data based on the logical block address identified.

23. A method of operating a hard disk drive apparatus, the method comprising:
reading data from a disk;
analyzing the data to identify a logical block address of the disk corresponding to the data; and
processing the data based on the logical block address identified.

24. A hard disk drive apparatus, comprising:
a disk having data to be recorded and read;
a head to read from the disk and record to the disk the data;
a controller to select a data format corresponding to an order in which the data is recorded by the head from a data zone disposed at an inner circumference of a disk to a data zone disposed at an outer circumference of the disk, and to analyze the data read by the head to identify a logical block address of the disk corresponding to the data; and
a processor to process the data based on the logical block address identified.

25. A method of operating a hard disk drive apparatus, the method comprising:
reading from and/or recording to a disk data;
selecting a data format corresponding to an order in which data is recorded;
analyzing the data read to identify a logical block address of the disk corresponding to the data read; and
processing the data based on the logical block address identified.

26. An apparatus usable with a hard disk drive having a disk, the apparatus comprising:
a controller to select a data format corresponding to an order in which the data is recorded from a data zone disposed at an inner circumference of the disk to a data zone disposed at an outer circumference of the disk based on the HDD being used in an environment conducive to at least one of vibrations and shock.

27. An apparatus usable with a hard disk drive having a disk, the apparatus comprising:
a controller to analyze the data to identify a logical block address of the data on the disk; and
a processor to process the data based on the logical block address identified.
